(19) United States
(12) Patent Application Publication
(10) Pub. No.: US 2020/0263906 A1
(43) Pub. Date: Aug. 20, 2020

(54) Experimentation Apparatus to Test for Heat Produced by Cavitation

(71) Applicant: Roger Sherman Stringham, Kilaeua, HI (US)

(72) Inventor: Roger Sherman Stringham, Kilaeua, HI (US)

(21) Appl. No.: 16/867,455

(22) Filed: May 5, 2020

Related U.S. Application Data
(63) Continuation-in-part of application No. 16/096,030, filed on Oct. 24, 2018, now abandoned.
(60) Provisional application No. 62/330,920, filed on May 3, 2016.

(51) Int. Cl. F24V 40/00; H02N 2/00

(52) U.S. Cl. CPC F24V 40/00; H02N 2/009; H02N 2/001; H02N 2/008

(57) ABSTRACT

An experimentation apparatus tests for heat produced by cavitation. The experimentation apparatus includes a heating chamber, a quantity of heavy water, a piezo-disk antenna, a target foil, a transmission line, a signal generator, a control unit, and at least one sensor. The heavy water is retained within the heating chamber and is agitated by the piezo-disk antenna to form cavitation bubbles. These cavitation bubbles impact the target foil in order to potentially produce deuteron combination events that could consequently produce heat. The signal generator sends an electrical signal along a transmission line to the piezo-disk antenna in order to dictate how the piezo-disk antenna vibrates within the heavy water. The control unit is used to manage the operational functionalities of the experimentation apparatus such as instructing the signal generator to adjust the frequency of the electrical signal. The at least one sensor collects experimentation data within the heating chamber.

The current application is a continuation-in-part (CIP) application of the U.S. non-provisional application Ser. No. 16/096,030 filed on Oct. 24, 2018. The U.S. non-provisional application Ser. No. 16/096,030 is a 371 of international Patent Cooperation Treaty (PCT) application PCT/IB2017/054017 filed on Jul. 3, 2017. The PCT application PCT/IB2017/054017 claims a priority to the U.S. Provisional Patent application Ser. No. 62/330,920 filed on May 3, 2016.

### FIELD OF THE INVENTION

The present invention generally relates to an apparatus that can be used to collect experimentation data for producing heat through cavitation by utilizing a piezo-disk antenna to agitate a reservoir of deuterium oxide (DOD). More specifically, the present invention can potentially generate heat by utilizing a radio frequency (RF) pulsing device to accelerate charged particles into a target foil.

### BACKGROUND OF THE INVENTION

Typically, heaters are devices that require a large power source to operate and to provide an adequate amount of heat. For example, an electric space heater is continuously supplied with power from an electric power plant. Also for example, a home's or building's heating system draws its heat from either a water boiler or a furnace. Other heaters need to burn consumables, such as oxygen and fuel, in order to generate the adequate amount of heat. The aforementioned heaters are cumbersome to operate in a variety of situations, one of which is in space exploration. The limited resources and storage space on a spaceship would make any of the aforementioned heaters difficulty to use in space exploration.

Therefore, an objective of the present invention is to collect experimentation data in an effort to potentially produce heat without carbon dioxide (CO2) pollution or dangerous radiation. Another objective of the present invention to collect experimentation data in an effort to potentially produce heat without a large power source or without using consumables such as fuel or oxygen. The present invention is configured to experiment with the following equation in order to potentially generate an adequate amount of heat:

B(2D;4He)=B(2p,2m;4He)−2B(p,m;D)=28.3−2×2.22=23.9MeV

wherein this equation governs deuteron (D+) combination.

Moreover, another objective of the present invention is to collect experimentation data in an effort to potentially produce heat on and in the Moon's surface caves, where heating is important. The present invention needs to be able to work in conjunction with a Radioisotope Thermoelectric Generator (RTG). The heavy water would always need to be a liquid in this implementation.

### BRIEF DESCRIPTION OF THE DRAWINGS

The patent or application file contains at least one drawing executed in color. Copies of this patent or patent application publication with color drawing(s) will be provided by the office upon request and payment of the necessary fee.

FIG. 1 is a schematic view of the present invention.

FIG. 2 is a detailed schematic view of the electronic components of the present invention.

FIG. 3 is a perspective view of an exemplary embodiment of the present invention.

FIG. 4 is a side view of the exemplary embodiment of the present invention.

FIG. 5 is a cross-section view of the exemplary embodiment of the present invention taken along line 5-5 in FIG. 4.

FIG. 6 is a detailed cross-section view of the piezo-disk antenna and the area surrounding the piezo-disk antenna.

FIG. 7 is a perspective view of the exemplary embodiment of the present invention that can potentially be configured into a space heater.

FIG. 8 is a photograph of a physical prototype of the present invention.

FIG. 9 is a photograph of a physical prototype of the present invention with a radiation detector to the right of the physical prototype.

FIG. 10 is a single electron microscope (SEM) photograph of an ejecta site of a Pd target foil exposed to 20 Kilohertz (KHz) cavitation showing the ejecta damage to the surface of the Pd target foil at a scale of 1700 micrometers (μm) across.

FIG. 11 is an SEM photograph of a single vent of the ejecta site shown in FIG. 10 at a scale of 20 μm across, wherein 1-μm spherical debris is located within the single vent.

FIG. 12 is an SEM photograph of an ejecta site of a Pd target foil exposed to 46 KHz cavitation showing the ejecta damage to the surface of the Pd target foil at a scale of 1 μm across.

FIG. 13 is a magnified SEM photograph of the ejecta site shown in FIG. 12 showing the diversity of the vents at the ejecta site.

FIG. 14 is an SEM photograph of an ejecta site of a Pd target foil exposed to 1.6 Megahertz (MHz) cavitation showing the ejecta damage to the surface of the Pd target foil at a scale of 1 μm across.

FIG. 15 is a magnified SEM photograph of the ejecta site shown in FIG. 14 showing the uniformity of the vents at the eject site.

### DETAILED DESCRIPTION OF THE INVENTION

All illustrations of the drawings are for the purpose of describing selected versions of the present invention and are not intended to limit the scope of the present invention.

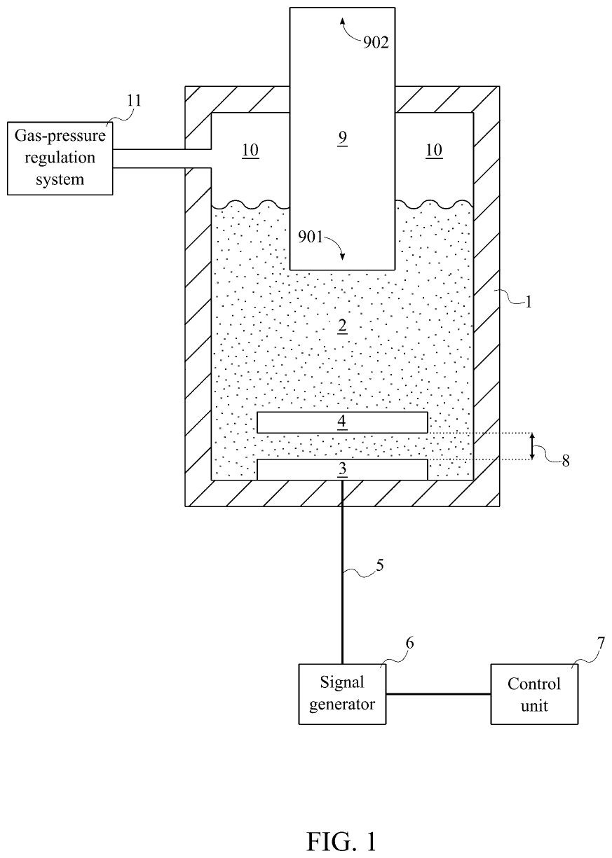

As can be seen in FIG. 1, the present invention is an apparatus that is used to collect experimentation data on agitating deuterium oxide (DOD) in order to create cavitation bubbles. Heat can potentially be generated by the present invention as these cavitation bubbles collapse, which could induce deuteron combination. The present invention may comprise a heating chamber 1, a quantity of heavy water 2, a piezo-disk antenna 3, a target foil 4, a transmission line 5, a signal generator 6, and a control unit 7. The heating chamber 1 is an enclosure that prevents outside contaminants from disrupting the collection of experimentation data. The quantity of heavy water 2 is used to create the experimentation conditions for scientific research on deuteron combination and is preferably composed of DOD. However, the present invention could alternatively be configured to create the experimentation conditions for scientific research on deuterium-tritium combination by also including tritium oxide within the quantity of heavy water 2. The piezo-disk antenna 3 is used to cyclically agitate the quantity of heavy water 2 in order to create a first set of cavitation bubbles. A subset of bubbles from the first set of cavitation bubbles is predicted to have a resonant size that will rapidly grow and adiabatically collapse into plasma jets, which include electrons (e⁻) and deuterium ions (D⁺). The plasma jets are first predicted to impact the e⁻ onto the target foil 4 and are then predicted to impact the D⁺ onto the target foil 4, which could increase the density of D⁺ at the target foil 4. Consequently, the target foil 4 is predicted to induce more D⁺ combination events as the current density of D⁺ at the target foil 4 could approach the necessary density of D⁺ for deuteron combination. The target foil 4 is preferably a metal lattice that can be made of, but is not limited to, Palladium, Titanium, Silver, Copper, Nickel, Carbon, Tungsten, or a combination thereof.

The piezo-disk antenna 3 is also used to acoustically vibrate the target foil 4 in order to create a second set of cavitation bubbles. The second set of cavitation bubbles follows the same process as the first set of cavitation bubbles in order to potentially produce even more D⁺ combination events at the target foil 4. Moreover, the signal generator 6 outputs an electrical signal that is communicated by the transmission line 5 to the piezo-disk antenna 3 so that the piezo-disk antenna 3 can convert the electrical signal into physical vibrations. The control unit 7 is used to manage and monitor the operational functionalities of the present invention.

The general configuration of the aforementioned components allows the present invention to efficiently and effectively experiment with the production of more D⁺ combination events at the target foil 4. Thus, the quantity of heavy water 2 is retained within the heating chamber 1, and the piezo-disk antenna 3 and the target foil 4 are mounted within the heating chamber 1. This arrangement creates an environment within the heating chamber 1, which could induce deuteron combination. In addition, the piezo-disk antenna 3 and the target foil 4 is positioned offset from each other by a gap distance 8 so that some amount of DOD can be located in between the piezo-disk antenna 3 and the target foil 4. Consequently, the present invention could be able produce D⁺ combination events on both faces of the target foil 4. The piezo-disk antenna 3 and the target foil 4 are also in vibration communication with each other through the quantity of heavy water 2, which allows the target foil 4 to physical vibrate with the piezo-disk antenna 3 and consequently allows the target foil 4 to create more cavitation bubbles in addition to the cavitation bubbles created by the piezo-disk antenna 3. Moreover, the transmission line 5 electrically connects the signal generator 6 to the piezo-disk antenna 3 in order to send an electrical signal from the signal generator 6 to the piezo-disk antenna 3. The signal generator 6 configures the electrical signal to produces a specific vibrational response from the piezo-disk antenna 3. The control unit 7 is electronically connected to the signal generator 6 so that the control unit 7 is able to modify or monitor certain properties of the electrical signal such as frequency or amplitude. In addition, the present invention electrically powers the control unit 7, the signal generator 6, and any other electrical components of the present invention with either an external power supply (e.g. variable 60-cycle autotransformer or an electrical outlet) or a portable power source (e.g. a direct current (DC) battery).

As can be seen in FIG. 1, the present invention may further comprise a heat exchanger 9 in order to convectively transfer heat out of the heating chamber 1 and consequently prevent the present invention from overheating. The heat exchanger 9 comprises an exchanger input 901 and exchanger output 902 that are used to control the heat flow out of the heating chamber 1. The exchanger input 901 is positioned inside of the heating chamber 1 and is in thermal communication with the target foil 4 through the quantity of heavy water 2, which allows the exchanger input 901 to receive the heat that could potentially be produced by the D⁺ combination events. The exchanger output 902 is positioned outside of the heating chamber 1, which allows the heat exchanger 9 to guide the heat flow into the surrounding environment of the heating chamber 1.

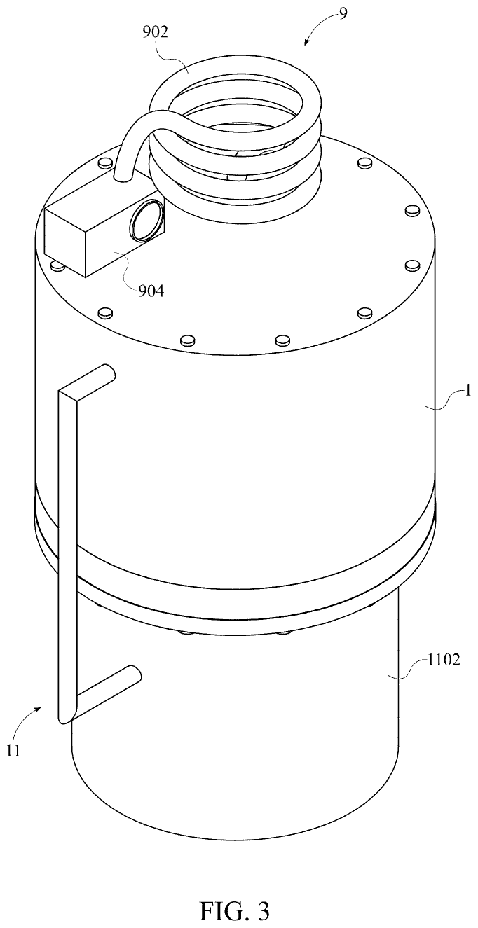

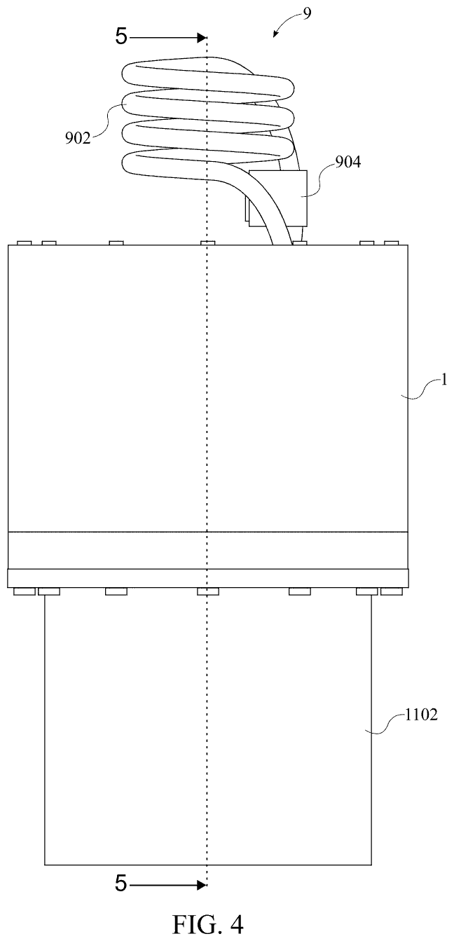

In an exemplary embodiment of the present invention, the heat exchanger 9 further comprises a coiled fluid line 903, a pump 904, and a quantity of heat-retaining fluid 905, which are shown in FIG. 3 through 5. The heat-retaining fluid 905 is used to receive heat that could potentially be generated within the heating chamber 1 and is then used to carry the heat out of the heating chamber 1. The heat-retaining fluid 905 is preferably water or another fluid with a similar high heat capacity. The heat-retaining fluid 905 is retained within the coiled fluid line 903 so that a first end of the coiled fluid line 903 is able to act as the exchanger input 901 and a second end of the coiled fluid line 903 is able to act as the exchanger output 902. The heat-retaining fluid 905 is also able to circulate through the coiled fluid line 903 because the first end of the coiled fluid line 903 and the second end of the coiled fluid line 903 are in fluid communication with each other. Moreover, the shape of the coiled fluid line 903 exposes more of the heat-retaining fluid 905 to the area enclosed by the heating chamber 1 and to the area surrounding the heating chamber 1, which allows for a more efficient heat exchange between those two areas. The pump 904 is used to drive the circulation for the heat-retaining fluid 905 through the coiled fluid line 903. Consequently, the pump 904 needs to be operatively integrated into the coiled fluid line 903 so that the pump 904 is able to drive a warmer portion of the heat-retaining fluid 905 from the first end of the coiled fluid line 903 to the second end of the coiled fluid line 903. This allows the warmer portion of the heat-retaining fluid 905 to be cooled at the second end of the coiled fluid line 903, outside of the heating chamber 1.

In reference to FIG. 1, the present invention may further comprise a quantity of noble gas 10, which is used stimulate the generation of cavitation bubbles within the quantity of heavy water 2. The quantity of noble gas 10 is preferably Argon because the polytrophic constant for Argon is approximately 1.6, which is better than the polytrophic constant for air (approximately 1.4). An adiabatic system is configured according to the following equation:

PV^{k}=constant

wherein P is the pressure, V is the volume, and k is the polytrophic constant. Because the k value is an exponent in the equation above, Argon has an advantage in potentially producing more power for the present invention. However, other kinds of noble gases can be used with the present invention with little to no downside. In further reference to FIG. 1, a gas-pressure regulation system 11 allows the present invention to monitor and adjust the pressure for the quantity of noble gas 10 so that the quantity of noble gas 10 does not adversely affect the generation of cavitation bubbles or any internal components within the heating chamber 1. Thus, the gas-pressure regulation system 11 needs to be in fluid communication with the heating chamber 1. The quantity of noble gas 10 is retained in between the gas-pressure regulation system 11 and the heating chamber 1, which allows portions of the noble gas 10 to move into or out of the gas-pressure regulation system 11 in order to increase or decrease the pressure of the noble gas 10 within the heating chamber 1.

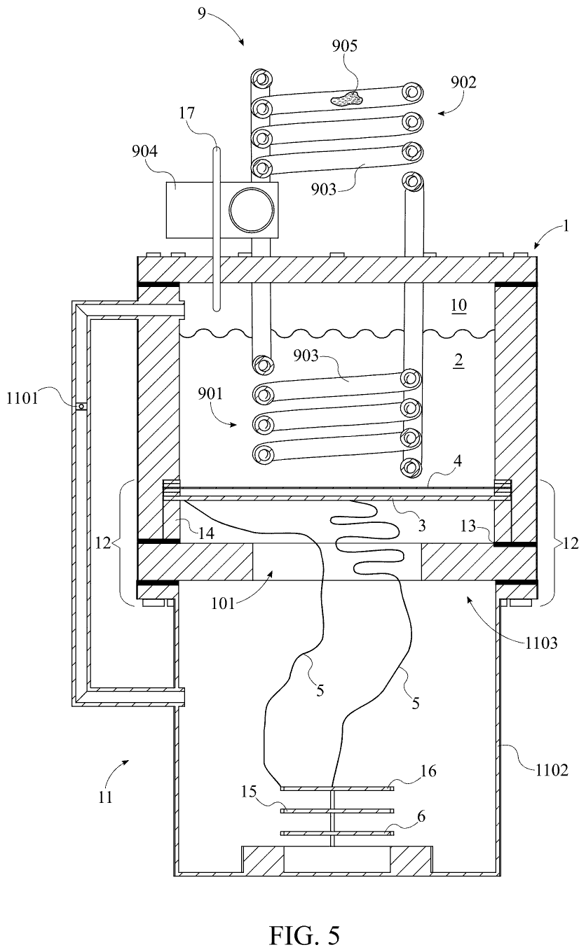

In an exemplary embodiment of present invention, the gas-pressure regulation system 11 comprises a control valve 1101 and a supplementary chamber 1102, which are specifically shown in FIG. 5. The supplementary chamber 1102 is used as an overflow reservoir for the quantity of noble gas 10. In order to improve the space-efficiency of the present invention, the piezo-disk antenna 3 is hermetically and peripherally mounted into an open end 101 of the heating chamber 1, and an open end 1103 of the supplementary chamber 1102 is connected adjacent to the open end 101 of the heating chamber 1. Consequently, the piezo-disk antenna 3 hermetically seals the open end 101 of the heating chamber 1 from the open end 1103 of the supplementary chamber 1102 so that no amount of heavy water can traverse from the heating chamber 1 into the supplementary chamber 1102. In addition, a separate fluid line allows the heating chamber 1 to be in fluid communication with the supplementary chamber 1102 through the control valve 1101, which allows portions of the noble gas 10 to traverse in between the heating chamber 1 and the supplementary chamber 1102. The control valve 1101 allows the gas-pressure regulating system to manage the flow of noble gas 10 in between the heating chamber 1 and the supplementary chamber 1102 and to prevent any heavy water 2 from traversing out of the heating chamber 1 through the separate fluid line. In order to further improve the space-efficiency of the present invention, the signal generator 6 can be mounted within the supplementary chamber 1102, while the transmission line 5 traverses through the supplementary chamber 1102 to the piezo-disk antenna 3.

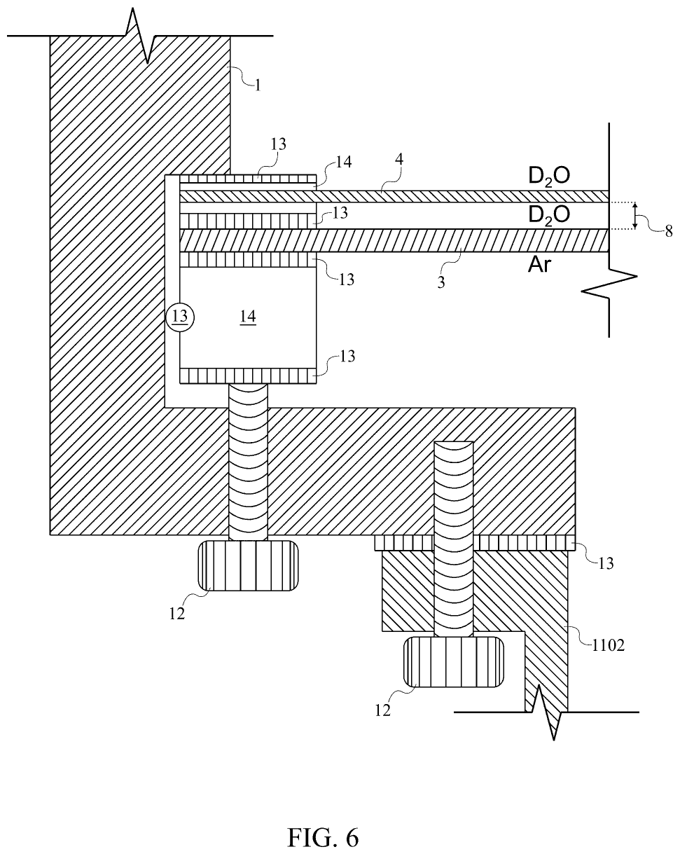

When the heating chamber 1 has an open end 101 that is hermetically sealed off by the piezo-disk antenna 3, the present invention may need to further comprise an annular clamp 12, at least one gasket 13, and at least one spacing ring 14, which are illustrate in FIGS. 5 and 6. The annular clamp 12 and the at least one spacing ring 14 are used to secure the piezo-disk antenna 3 into the open end 101 of the heating chamber 1, while the at the least one gasket 13 forms the hermetic seal between the open end 101 of the heating chamber 1 and the piezo-disk antenna 3. Thus, the at least one gasket 13, the at least one spacing ring 14, the target foil 4, and the piezo-disk antenna 3 need to be peripherally positioned into the open end 101 of the heating chamber 1. In addition, the at least one gasket 13 and the at least one spacing ring 14 are configured to the maintain the gap distance 8 between the target foil 4 and the piezo-disk antenna 3 by interspersing any number of gaskets and spacing rings amongst the target foil 4 and the piezo-disk antenna 3. The annular clamp 12 is used to apply a peripheral pressure onto the at least one gasket 13, the at least one spacing ring 14, the target foil 4, and the piezo-disk antenna 3 so that the at least one gasket 13, the at least one spacing ring 14, the target foil 4, and the piezo-disk antenna 3 are pressed in between the heating chamber 1 and the annular clamp 12. In addition, the at least one gasket 13 is preferably made of neoprene, and the at least one spacer ring 14 is preferably made of polytetrafluoroethylene.

Some components of the present invention can be configured to certain specifications in order to more efficiently and more effectively experiment with the potential production of heat. One such specification is to have the gap distance 8 between the target foil 4 and the piezo-disk antenna 3 be 0.25 of a wavelength for an electrical signal outputted by the signal generator 6, which allows the target foil 4 to be positioned for optimal agitation by the piezo-disk antenna 3. Another such specification is to have the signal generator 6 be configured to output an electrical signal with a resonance frequency of the piezo-disk antenna 3 so that the piezo-disk antenna 3 is driven to optimal agitation by the signal generator 6. Another such specification is to have the resonance frequency of the piezo-disk antenna 3 be within the radio-frequency (RF) band, which provides a better cavitation stimulus with the quantity of heavy water 2. The RF band is a preferable input for the piezo-disk antenna 3 because vibrating the piezo-disk antenna 3 at the RF band produces small frequency-responsive bubbles and their bubble-frequency overtones.

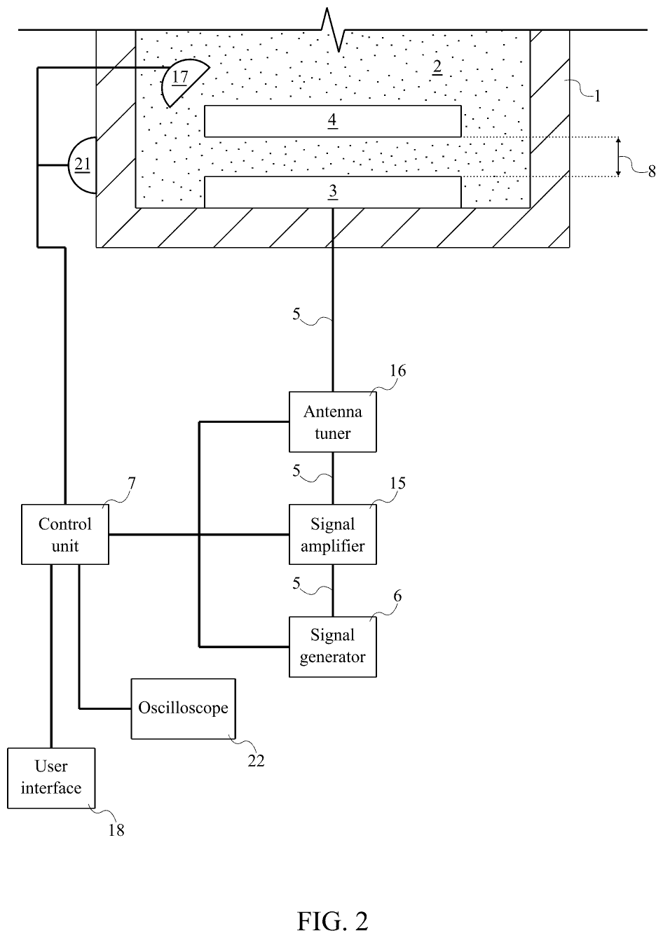

As can be seen in FIGS. 2 and 5, the present invention may further comprise a signal amplifier 15 and an antenna tuner 16 in order to modify the electrical signal that travels from the signal generator 6 to the piezo-disk antenna 3. The signal amplifier 15 is used to increase the magnitude of the electrical signal, which allows the electrical signal to be converted into macroscopic vibrations by the piezo-disk antenna 3. Moreover, the signal amplifier 15 is electrically integrated along the transmission line 5 so that the signal amplifier 15 is able to increase the magnitude of the electrical signal, before the electrical signal reaches the piezo-disk antenna 3. The signal amplifier 15 is electronically connected to the control unit 7, which allows the control unit 7 to adjust the factor by which the magnitude of the electrical signal is increased by the signal amplifier 15. In addition, the antenna tuner 16 is used to modulate other characteristics of electromagnetic (EM) waves, such as reactance, frequency, and phase. Similar to the signal amplifier 15, the antenna tuner 16 is electrically integrated along the transmission line 5 so that the signal amplifier 15 is able to adjust the electrical signal for resonance at the piezo-disk antenna 3, before the electrical signal reaches the piezo-disk antenna 3. In addition, the antenna tuner 16 functions by adjusting the inductance of the transmission line 5 to the piezo-disk antenna 3, which minimizes the reactance and maximizes the power in the gap distance 8, similar to an analog radio. The antenna tuner 16 is electronically connected to the control unit 7, which allows the control unit 7 to adjust how those other characteristics are modified by the antenna tuner 16. Moreover, the present invention is preferably configured to vibrate the piezo-disk antenna 3 and the target foil 4 at the same resonance frequency. However, if the piezo-disk antenna 3 and the target foil 4 vibrate at slightly different frequencies, the present invention will produce a beat frequency. The electrical signal is adjusted by the antenna tuner 16 in order to remove the beat frequency because the present invention is optimized to operate at a single tuned frequency.

In reference to FIG. 2, the present invention may further comprise at least one internal sensor 17, which is used to collect data on how much heat is being produced by the present invention and/or is used to continuously monitor certain diagnostic conditions of the present invention. For example, the internal sensor 17 could be a temperature internal sensor (e.g. a K-type thermocouple in an aluminum sheath) within the quantity of heavy water 2 that allows the present invention to measure the increase in temperature within the heating chamber 1 as the target foil 4 could potentially produce more a′ combination events, which would allow a heavy-water circulation in the gap distance 8. The configuration of the target foil 4 is possibly shaped to be a rectangle, which would allow for free circulation of the quantity of heavy water 2 around the target foil 8. Another example is a Geiger Muller counter that is positioned offset from the target foil 4 in order to detect any abnormal radiation from the present invention. Thus, the at least one internal sensor 17 needs to be mounted within the heating chamber 1 in order to monitor the experimentation and/or diagnostic conditions within the heating chamber 1 during the operation of the present invention. The at least one internal sensor 17 is electronically connected to the control unit 7 so that the control unit 7 is able to receive and process the data gathered by the at least one internal sensor 17. This also allows the control unit 7 to provide warning notifications in case of a malfunction in the present invention. In addition, some configurations for the at least one internal sensor 17 are able to monitor the important parameters for the present invention, which are power, temperature, and pressure. Those configurations of the at least one internal sensor 17 are able to monitor the proportional ratio between the pressure and the temperature multiplied by the power.

Again, in reference to FIG. 2, the present invention may further comprise at least one acoustic sensor 21 and an oscilloscope 22. The at least one acoustic sensor 21 is used to collect data on physical vibrations that are acoustically generated by the piezo-disk antenna 3 and the target foil 4, while the oscilloscope 22 is used to visually output the collected data to a researcher. Moreover, the at least one acoustic sensor 21 is able to sense a set of measurable wave properties of those physical vibrations, such as, but not limited to, phase, frequency, and amplitude, and creates a continuous record of those measurable wave properties that can then be visually outputted with the oscilloscope 22. The at least one acoustic sensor 21 is external mounted to the heating chamber 1, which allows the at least one acoustic sensor 21 to be in vibrational communication with the piezo-disk antenna 3 and the target foil 4 through the quantity of heavy water 2 and the heating chamber 1. The at least one acoustic sensor 21 is preferably a plastic acoustic sensor strip that is made of polyvinylidene difluoride (PVDF) because PVDF is very sensitive to frequencies in the Megahertz (MHz) range. The plastic acoustic sensor strip can be attached to an outside surface of the heating chamber 1 with electrical tape. The at least one acoustic sensor 21 is positioned adjacent to the gap distance 8 so that the at least one acoustic sensor 21 is better able to sense the physical waves that are acoustically generated by the piezo-disk antenna 3 and the target foil 8 by being in the closest possible proximity to the piezo-disk antenna 3 and the target foil 8 without interfering with the generation of those physical waves. In addition, the at least one acoustic sensor 21 and the oscilloscope 22 are electronically connected to the control unit 7 so that the control unit 7 is able to receive and process the data gathered by the at least one acoustic sensor 21 and is then able to route this data to the oscilloscope 22. This allows the oscilloscope 22 to visually output the data for those physical vibrations in a standard scientific manner for the researcher. This also allows the control unit 7 to manage a feedback loop between the data that is collected by the at least one acoustic sensor 21 and the adjustments that are being made by the antenna tuner 16 to the electrical signal travelling from the signal generator 6 to the piezo-disk antenna 3 in order to remove a beat frequency from the physical vibrations of the piezo-disk antenna 3 and the target foil 4.

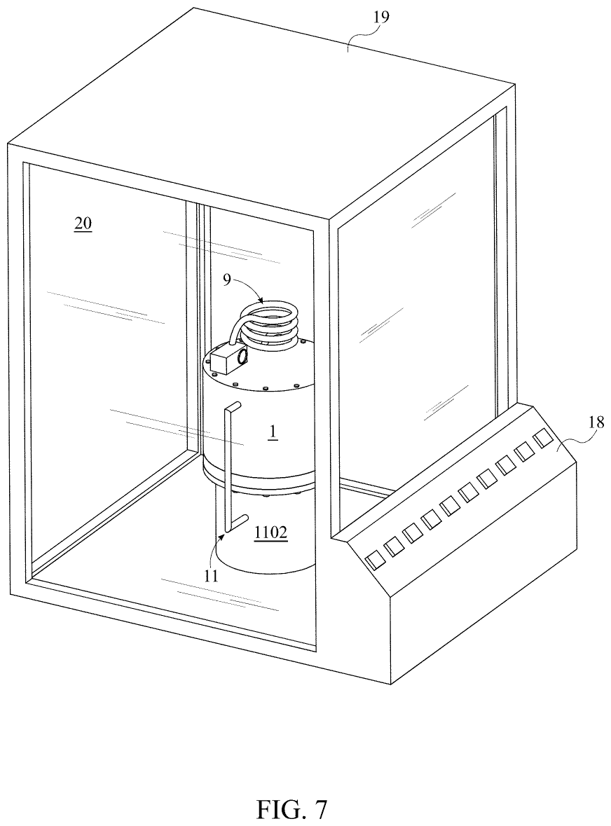

As can be seen in FIGS. 2 and 7, the present invention may further comprise a user interface 18 that allows a researcher to adjust and control various operational conditions and functionalities of the present invention and/or allows a researcher to view the experimentation data being collected by the present invention. Consequently, the user interface 18 needs to be electronically connected to the control unit 7 so that the researcher can input and output information and commands to/from the control unit 7. For example, the researcher would be able to adjust some characteristics of the electrical signal through the user interface 18 or would be able to view the sensing data from the at least one internal sensor 17. The user interface 18 may also allow the researcher to turn the present invention on and off, to control a power supply for the present invention, to manually adjust the electrical signal with the antenna tuner 16, to view the potential watts output, to view the water-flow rate, and to control the pressure for the quantity of noble gas 10. The user interface 18 could also be used to visually output the data gathered by the at least one acoustic sensor 21 as a way to substitute the functionality of the oscilloscope 22.

In one embodiment, the present invention is configured to better retain the heat that could potentially be generated by D⁺ combination events. Thus, the present invention further comprises a containment tank 19 and a quantity of heat-sinking fluid 20, which are shown in FIG. 7. The quantity of heat-sinking fluid 20 is preferably water or another fluid with a similar high heat capacity and provides a thermal means of retaining the heat generated within the heating chamber 1. The quantity of heat-sinking fluid 20 prevents the heat generated within the heating chamber 1 from easily escaping the confines of the present invention. In addition, the heat exchanger 9 is also able to extract the heat from within the heating chamber 1, to transfer the heat outside of the heating chamber 1, and to deposit the heat into the quantity of heat-sinking fluid 20. In order to submerge the heating chamber 1 within the quantity of heat-sinking fluid 20, the quantity of heat-sinking fluid 20 needs to be retained within the containment tank 19, and the heating chamber 1 needs to be mounted within the containment tank 19. This embodiment allows the present invention to potentially function as a space heater to heat the surrounding area or as a water heater to delivery hot water to external outlets. Moreover, the containment tank 19 should be configured to contain the piezo-disk antenna 3 as a source of radio-frequency interference (RFI) so that any RF related devices in the surrounding areas are not affected by the operation of the present invention. The heating chamber 1 could also be configured to contain the piezo-disk antenna 3 as a source of RFI. The containment tank 19 or the heating chamber 1 is preferably made of polycarbonate base with an integrated metal screening.

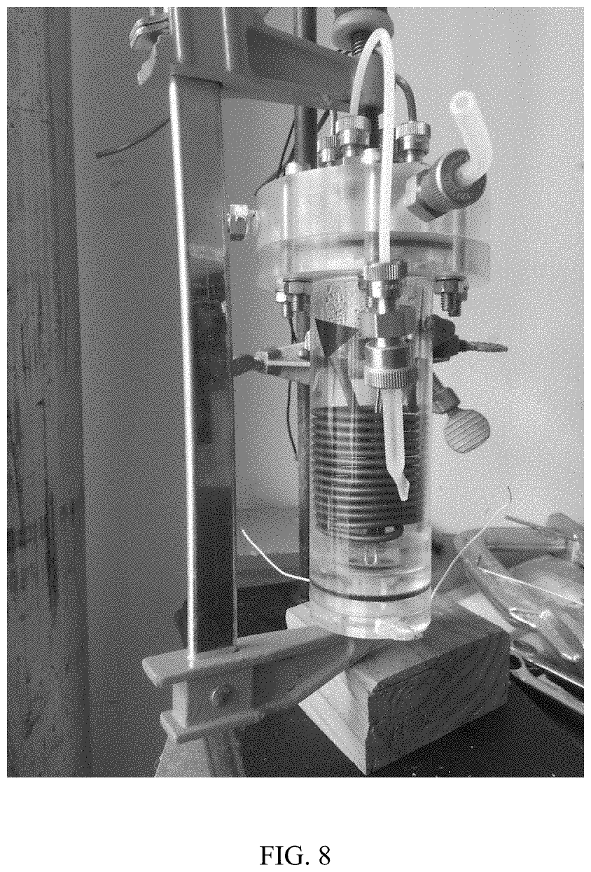

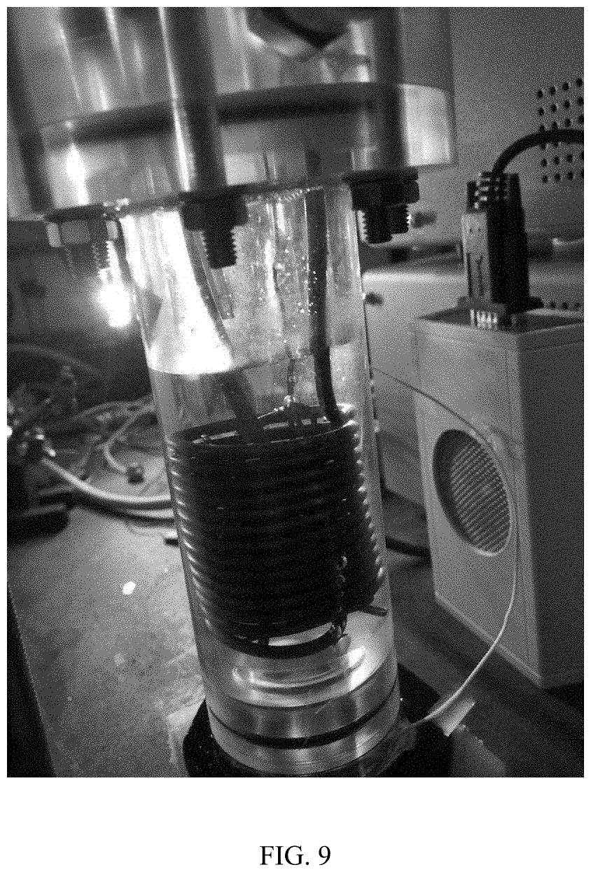

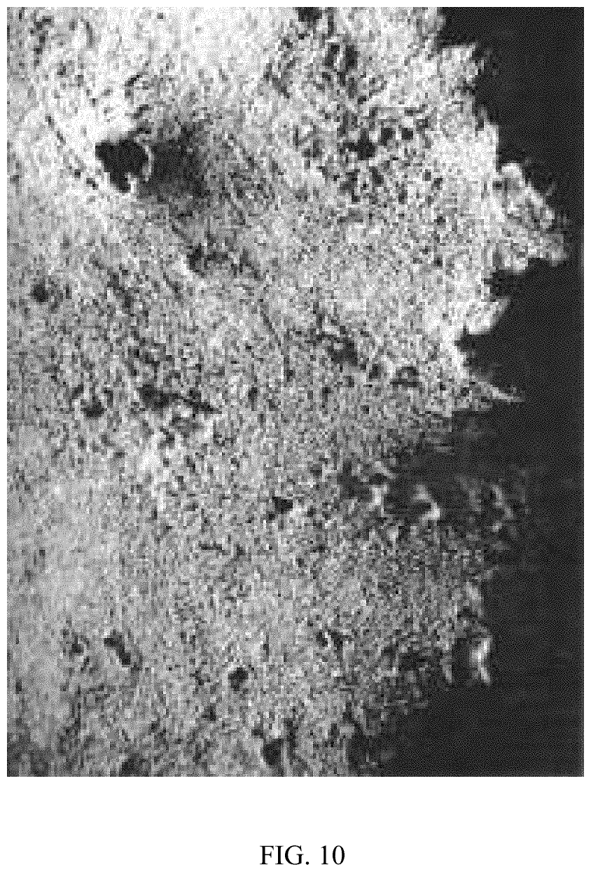

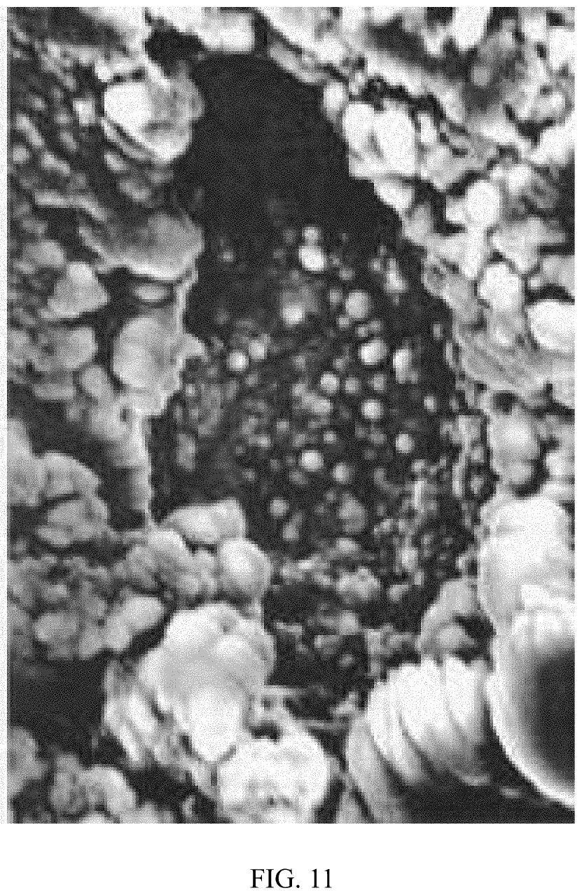

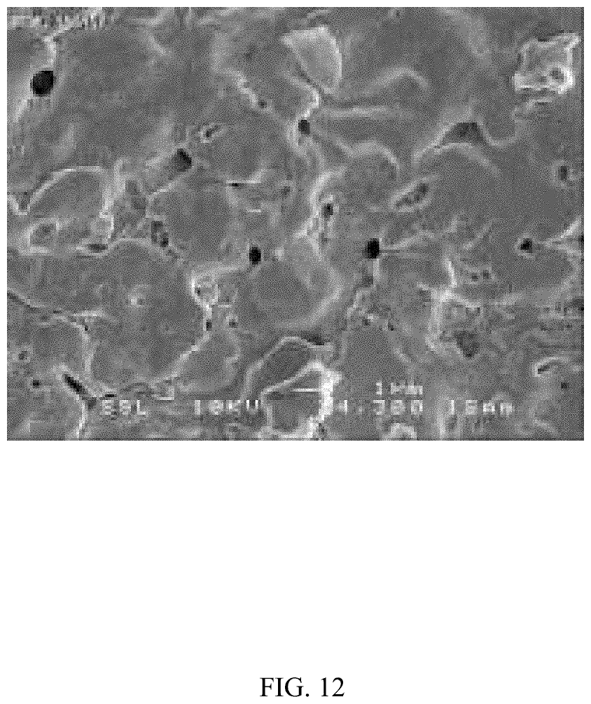

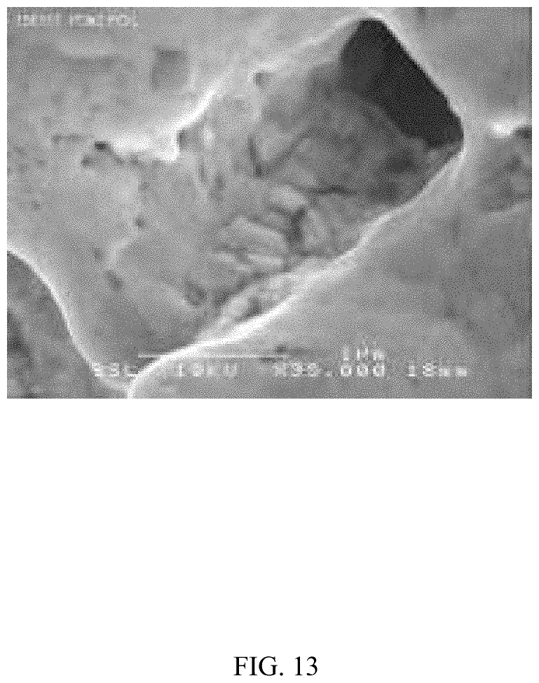

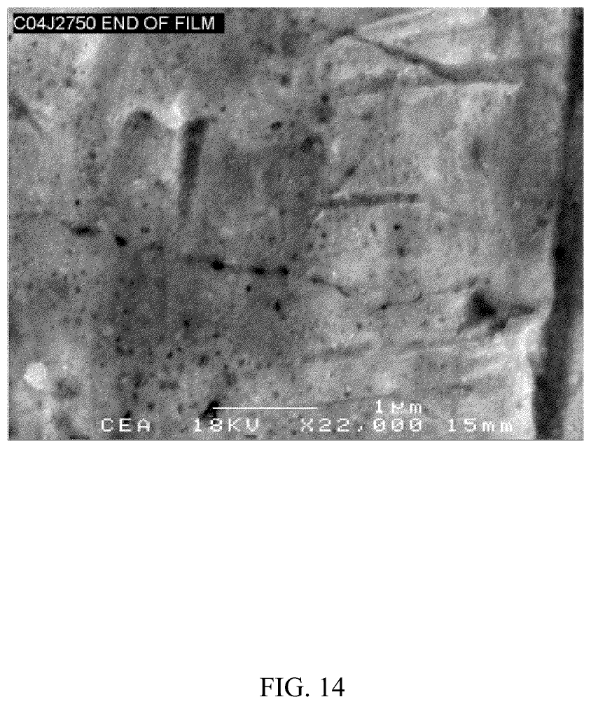

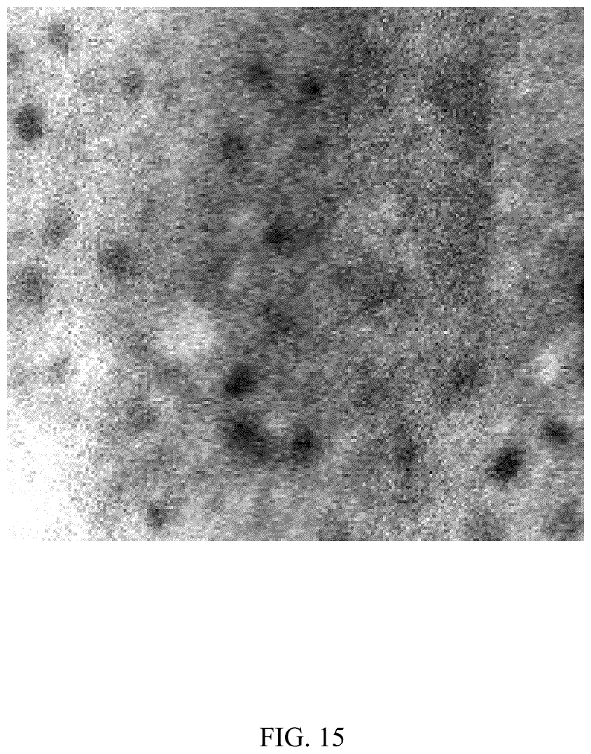

Furthermore, the functionality of the present invention is to collect experimentation data on 4He and heat measurements, which requires the manually-built prototypes shown in FIGS. 8 and 9. As can be seen in FIGS. 10 through 15, microscopic images have been taken of the target foil 4 after the present invention was in use. The microscopic images show that craters were formed on both sides of the target foil 4 and further show that the diameter of those craters is inversely proportional to the frequency outputted by the piezo-disk antenna 3. These craters are assumed be formed by D⁺ combination events that are potentially induced by the present invention. The density of craters on both sides of the target foil 4 also show that the present invention is able to potentially induce the D⁺ combination events at an efficient and effective rate. Thus, the present invention does not claim to have achieved an efficient and effective mechanism of generating D⁺ combination events, but the present invention is configured as an experimentation apparatus to do scientific research on the possibility of effectively and efficiently generating D⁺ combination events in order to potentially produce heat.

Although the invention has been explained in relation to its preferred embodiment, it is to be understood that many other possible modifications and variations can be made without departing from the spirit and scope of the invention as hereinafter claimed.

What is claimed is:

1. An experimentation apparatus to test for heat produced by cavitation comprising:
a heating chamber;
a quantity of heavy water;
a piezo-disk antenna;
a target foil;
a transmission line;
a signal generator;
a control unit;
at least one internal sensor;
a signal amplifier;
an antenna tuner;
a user interface;
the quantity of heavy water being retained within the heating chamber;
the piezo-disk antenna and the target foil being mounted within the heating chamber;
the piezo-disk antenna and the target foil being positioned offset from each other by a gap distance;
the piezo-disk antenna and the target foil being in vibrational communication with each other through the quantity of heavy water;
the piezo-disk antenna being electrically connected to the signal generator by the transmission line;
the signal generator being electronically connected to the control unit;
the at least one internal sensor being mounted within the heating chamber;
the signal amplifier and the antenna tuner being electrically integrated along the transmission line; and
the at least one internal sensor, the signal amplifier, the antenna tuner, and the user interface being electronically connected to the control unit.

2. The experimentation apparatus to test for heat produced by cavitation as claimed in claim 1 comprising:
a heat exchanger;
the heat exchanger comprising an exchanger input and an exchanger output;
the exchanger output being positioned outside of the heating chamber;
the exchanger input being positioned inside of the heating chamber; and
the exchanger input and the target foil being in thermal communication with each other through the quantity of heavy water.

3. The experimentation apparatus to test for heat produced by cavitation as claimed in claim 2 comprising:
the heat exchanger further comprising a coiled fluid line, a pump, and a quantity of heat-retaining fluid;
a first end of the coiled fluid line being the exchanger input;
a second end of the coiled fluid line being the exchanger output;
the first end of the coiled fluid line and the second end of the coiled fluid line being in fluid communication with each other;
the quantity of heat-retaining fluid being retained within the coiled fluid line; and
the pump being operatively integrated into the coiled fluid line, wherein the pump is used to circulate the quantity of heat-retaining fluid through the coiled fluid line.

4. The experimentation apparatus to test for heat produced by cavitation as claimed in claim 1 comprising:
a quantity of noble gas;
a gas-pressure regulation system;
the gas-pressure regulation system being in fluid communication with the heating chamber; and
the quantity of noble gas being retained in between the gas-pressure regulation system and the heating chamber.

5. The experimentation apparatus to test for heat produced by cavitation as claimed in claim 4, the quantity of noble gas is Argon.

6. The experimentation apparatus to test for heat produced by cavitation as claimed in claim 4 comprising:
the gas-pressure regulation system comprising a control valve and a supplementary chamber;
the piezo-disk antenna being hermetically and peripherally mounted into an open end of the heating chamber;
an open end of the supplementary chamber being connected adjacent to the open end of the heating chamber, wherein the piezo-disk antenna hermetically seals the open end of the heating chamber from the open end of the supplementary chamber; and
the heating chamber being in fluid communication with the supplementary chamber through the control valve.

7. The experimentation apparatus to test for heat produced by cavitation as claimed in claim 6 comprising:
the signal generator being mounted within the supplementary chamber; and
the transmission line traversing through the supplementary chamber.

8. The experimentation apparatus to test for heat produced by cavitation as claimed in claim 1 comprising:
an annular clamp;
at least one gasket;
at least one spacing ring;
the at least one gasket, the at least one spacing ring, the target foil, and the piezo-disk antenna being peripherally positioned into an open end of the heating chamber; and
the at least one gasket, the at least one spacing ring, the target foil, and the piezo-disk antenna being pressed in between the heating chamber and the annular clamp.

9. The experimentation apparatus to test for heat produced by cavitation as claimed in claim 8, wherein the at least one gasket and the at least one spacing ring is configured to maintain the gap distance between the target foil and the piezo-disk antenna.

10. The experimentation apparatus to test for heat produced by cavitation as claimed in claim 1, wherein the gap distance is 0.25 of a wavelength for an electrical signal outputted by the signal generator.

11. The experimentation apparatus to test for heat produced by cavitation as claimed in claim 1, wherein the signal generator is configured to output an electrical signal with a resonance frequency of the piezo-disk antenna.

12. The experimentation apparatus to test for heat produced by cavitation as claimed in claim 11, wherein the resonance frequency of the piezo-disk antenna is within the radio-frequency (RF) band.

13. The experimentation apparatus to test for heat produced by cavitation as claimed in claim 1 comprising:
at least one acoustic sensor;
the at least one acoustic sensor being externally mounted to the heating chamber;
the at least one acoustic sensor being positioned adjacent to the gap distance; and
the at least one acoustic sensor being electronically connected to the control unit.

14. The experimentation apparatus to test for heat produced by cavitation as claimed in claim 1 comprising:
an oscilloscope; and
the oscilloscope being electronically connected to the control unit.

15. The experimentation apparatus to test for heat produced by cavitation as claimed in claim 1 comprising:
a containment tank;
a quantity of heat-sinking fluid;
the quantity of heat-sinking fluid being retained within the containment tank; and
the heating chamber being mounted within the containment tank.

16. The experimentation apparatus to test for heat produced by cavitation as claimed in claim 15, wherein the containment tank is configured to contain the piezo-disk antenna as a source of radio-frequency interference (RFI).

17. The experimentation apparatus to test for heat produced by cavitation as claimed in claim 1, wherein the heating chamber is configured contain the piezo-disk antenna as a source of radio-frequency interference (RFI).

18. The experimentation apparatus to test for heat produced by cavitation as claimed in claim 1, wherein the target foil is a metal lattice material selected from a group consisting of: Palladium, Titanium, Silver, Copper, Nickel, Carbon, Tungsten, and a combination thereof.
